(19) United States
(12) Patent Application Publication
(10) Pub. No.: US 2010/0140212 A1
(43) Pub. Date: Jun. 10, 2010

(54) PROCESS FOR PREPARING GRATING TOOLS

(76) Inventor: KING-YEUNG LI, Hong Kong (HK)

Correspondence Address: PAULEY PETERSEN & ERICKSON, 2800 WEST HIGGINS ROAD, SUITE 365, HOFFMAN ESTATES, IL, 60169, US

(21) Appl. No.: 12/572,054

(22) Filed: Oct. 1, 2009

Related U.S. Application Data
(60) Provisional application No. 61/201,376, filed on Dec. 10, 2008.

(51) Int. Cl. B44C 1/22

(52) U.S. Cl. 216/11

(57) ABSTRACT

A process for making a grating tool includes the steps of providing a metal blank having first and second surfaces, defining a first pattern on the first surface having a plurality of exposed areas, etching the first surface in the exposed areas of the first pattern, defining a second pattern on the second surface having a plurality of exposed areas corresponding to exposed areas of the first pattern, etching the second surface in the exposed areas to form openings and blades in the exposed areas of the second pattern corresponding to exposed areas of the first pattern, and stamping the metal blank so that the blades project at an angle above one of the first and second surfaces. The process results in a grating tool having improved blade orientation, blade sharpness and ease of cutting.

This patent application claims priority under 35 U.S.C. §119(e)(1) to U.S. Provisional Application 61/201,376 filed on Dec. 10, 2008, the disclosure of which is incorporated by reference.

### FIELD OF THE INVENTION

This invention is directed to a process for preparing a grating tool, in particular a kitchen grating tool having stamped angular blades.

### BACKGROUND OF THE INVENTION

Kitchen grating tools having stamped angular blades are known from U.S. Pat. No. 5,100,506 to Sturtevant et al. The angular blades are formed by chemically etching a sheet metal blank from one side only to form openings defining the blades, and then stamping the blades to cause them to protrude at a slight angle from the cutting side of the instrument. Stamped angular blades are intended to be sharper, and to provide easier and better grating of food products, compared to older grating tools which utilize vertical abrading protrusions instead of angular blades. Exemplary grating tools having vertical abrading protrusions are described in U.S. Pat. No. 3,045,321 to McDermott.

According to the above Sturtevant et al. patent, suitable grating tools cannot be made using a chemical etching process that etches both sides of a sheet metal blank. Such grating tools are said to be dull and do more rubbing than cutting. According to Sturtevant et al., suitable grating tools can be made by chemically etching from one side, but not from both sides, to form the blades.

### SUMMARY OF THE INVENTION

The present invention is directed to a process for making a grating tool, such as a kitchen grating tool having stamped angular blades. The process results in a grating tool whose blades are sharper and cut more easily than conventional grating tools. In one embodiment, the process includes the steps of providing a metal blank having first and second surfaces, defining a first pattern on the first surface having a plurality of exposed areas, etching the first surface in the exposed areas of the first pattern, defining a second pattern on the second surface having a plurality of exposed areas corresponding to exposed areas of the first pattern, etching the second surface in the exposed areas to form openings and blades in the exposed areas of the second pattern corresponding to the exposed areas of the first pattern, and stamping the metal blank so that the blades project at an angle relative to one of the first and second surfaces.

In another embodiment, the process includes the steps of providing a metal blank having first and second surfaces, treating the first surface in a first pattern defining exposed areas and resistant areas, etching the first surface in the exposed areas of the first pattern, treating the second surface in a second pattern defining exposed areas corresponding to exposed areas of the first pattern and resistant areas, etching the second surface in the exposed areas of the second pattern to form openings and blades in the exposed areas of the second pattern corresponding to exposed areas of the first pattern, and stamping the metal blank so that the blades project at an angle relative to one of the first and second surfaces.

In another embodiment, the process includes the steps of providing a metal blank having first and second opposing surfaces, applying an etching resistant material on the first surface in a first pattern defining exposed areas and resistant areas, masking the second surface, etching the first surface in the exposed areas of the first pattern while the second surface is masked, unmasking the second surface, applying an etching resistant material on the second surface in a second pattern defining exposed areas corresponding to exposed areas in the first pattern and resistant areas, masking the first surface, etching the second surface in the exposed areas of the second surface while the first surface is masked, and unmasking the first surface, wherein the etching of the first and second surfaces forms openings and blades in the corresponding exposed areas of the first and second patterns.

The resulting grating tool has improved blade sharpness due to the controlled etching of both opposing surfaces, according to the inventive process. The process can be used to make kitchen grating tools for food, grating tools for personal grooming such as the removal of calluses, and workshop grating tools for removing small amounts of wood and other materials.

With the foregoing in mind, it is a feature and advantage of the invention to provide a process for making durable grating tools having improved sharpness and ease of cutting.

### BRIEF DESCRIPTION OF THE DRAWINGS

FIGS. 1(a)-1(d) schematically illustrate the process of the invention using side sectional views of a metal blank as it is being processed.

FIGS. 2-5 illustrate alternative grating plate and blade configurations that can be used in the grating tool and made according to the process of the invention.

FIG. 6 is a top perspective view of an exemplary grating tool whose plate can be made according to the process of the invention.

### DETAILED DESCRIPTION OF THE EXEMPLARY EMBODIMENTS

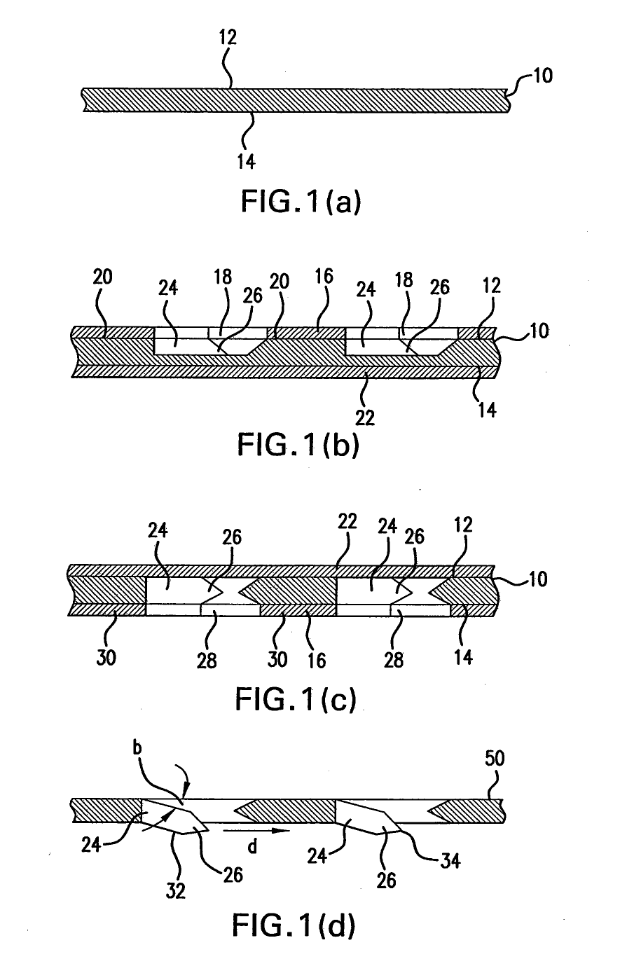

Referring to FIG. 1(a), a metal blank 10 is shown in expanded sectional view, with its visible axis corresponding to a portion of the long axis of the ultimate grating plate. The metal blank 10 has a first surface 12 and a second opposing surface 14. The metal blank 10 can be formed of any suitable metal that forms a strong, corrosion-resistant tool for cutting. Suitable metals include without limitation stainless steel, titanium, titanium-coated steel, nano-coated steel and any combination or alloy that includes one or more of these materials. A particularly suitable nano-coated steel is stainless steel coated with nano-sized particles of mineral oxides for resistance to corrosion, abrasion and microbial growth. Such nano-coatings are available from E.I. duPont DeNemours & Co. Other suitable metals include nickel, aluminum, copper, brass, and combinations and alloys thereof. The metal blank 10 may have a thickness of about 50 to about 500 microns for most grating applications. Certain applications may warrant greater or lesser thickness depending on the strength required and the type of metal used.

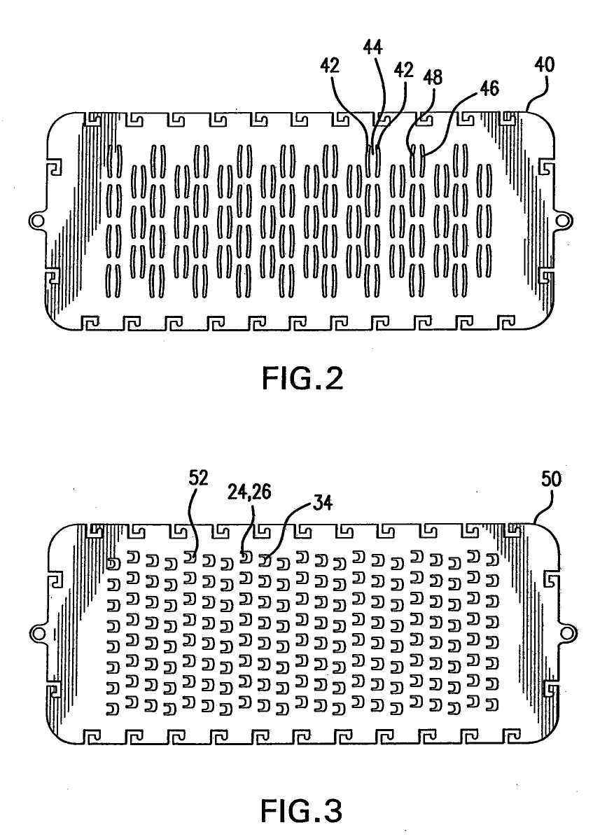

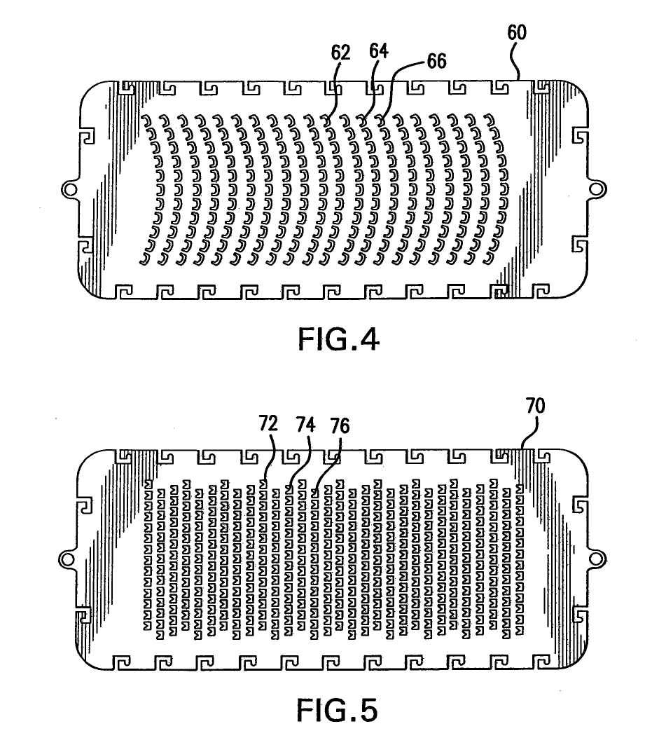

Referring to FIG. 1(b), an etching resistant material 16 or other suitable treatment can be applied to the first surface 12 in a pattern defining exposed areas 18 and etching resistant areas 20. Etching resistant areas 20 are covered by the etching resistant material 16. The exposed areas 18 may correspond to teeth and blades in the grating plate to be formed, as illustrated in any of FIGS. 2-5, particularly FIG. 3 or 4 described further below. The etching resistant material 16 may be any material that protects the covered portions of the first surface 12 from the etching solution. Suitable etching resistant materials include without limitation plastic sheets or printing inks which can be temporarily bound or applied to first surface 12 in the desired pattern. A layer of masking material 22 can be applied to the second surface 14 and may cover all or substantially all of the second surface 14. The masking material 22 can be any material that protects the second surface 14 from the etching solution, and may be the same or different from the etching resistant material 16. Suitable masking materials 22 include without limitation the aforementioned plastic sheets or printing inks which can be temporarily bound or applied to second surface 14. Prior to applying the etching resistant and masking materials, the surfaces of metal blank 10 may be cleaned with isochrone liquid or another suitable cleaning solvent to remove grease, dirt and the like.

The etching solution may be applied to the exposed areas 18 of the first pattern on the first surface 12 by dipping the metal blank 10 in the etching solution, or by spraying, roll coating, brush coating or another suitable technique. The etching solution may be aqueous sulfuric acid, nitric acid, hydrochloric acid, hydrofluoric acid, or another suitable etching solution. A particularly suitable etching solution is a mixture of aqueous hydrochloric acid and ferric trichloride at a ratio of 4 parts by weight hydrochloric acid per 6 parts by weight ferric trichloride. The etching of the first surface 12 can proceed in the exposed areas 18 of the first pattern on the first surface 12 by dipping the metal blank 10 in the etching solution, or by spraying, roll coating, brush coating or another suitable technique. The etching of the first surface 12 can proceed in the exposed areas 18 to a depth which is typically greater than about 50% of a thickness of the metal blank 10, suitably at least about 55% of the thickness, or about 55-75% of the thickness. The etching of the exposed areas 18 forms at least the upper portion of teeth 24 defining blades 26. The etching may be facilitated with a conventional laser etching process.

After the etching of the first surface 12 is completed, the metal blank 10 can be sprayed or immersed in water to stop the etching. The etching resistant material 16 is removed from the first surface 12 and the masking material 22 is removed from the second surface 14. Referring to FIG. 1(c), a layer of the etching resistant material 16 can then be applied to the second surface 14 in a second pattern defining exposed areas 28, at least some of which correspond to exposed areas 18 in the first pattern, and etching resistant areas 30. In one embodiment, the second pattern is a mirror image of the first pattern so that all of the exposed areas 28 correspond to exposed areas 18 and all of the etching resistant areas 30 correspond to etching resistant areas 20. A layer of the masking material 22 can be applied to the first surface 12 and can cover all or substantially all of the first surface 12. Both the etching resistant material 16 and the masking material 22 can be temporarily adhesively bound or heat sealed to the respective surfaces 14 and 12.

The etching solution may then be applied to the exposed areas 28 of the second pattern on the second surface 14 by dipping the metal blank 10 in the etching solution or by spraying, roll coating, brush coating or another suitable technique. The etching of the second surface 12 proceeds in the exposed areas 28 until the teeth 24 defining blades 26 are completely formed, i.e., until the etching completely penetrates the remaining thickness of the metal blank 10 in the exposed areas 28. In order to accomplish this, the etching of second surface 14 in exposed areas 28 may typically penetrate less than about 50% of the thickness of metal blank 10, suitably not more than about 45% of the thickness, or about 25-45% of the thickness. Again, the etching may be facilitated with a laser etching process.

After etching of the second surface 14 is completed, the metal blank 10 can be sprayed or immersed in water to stop the etching. The etching resistant material 16 is removed from the second surface 14 and the masking material 22 is removed from the first surface 12. Because the etching through the first surface 12 proceeded to a greater extent than the etching through the second surface 14, the blades 26 have very sharp edges that are slightly biased toward the second surface 14 as shown in FIG. 1(c).

The metal blank 10 is then stamped in the region of the teeth 24 using conventional methods to cause the teeth 24 and blades 26 to protrude at a small angle “b” relative to the second surface 14. Referring to FIG. 1(d), the angle “b” may range from about 5-30 degrees, and is suitably about 10-20 degrees. The combination of a) etching from both sides as shown in FIGS. 1(b) and 1(c), b) with the etching being asymmetrically greater from the first surface 12 than from the second surface 14, and c) biasing the teeth 24 below the second surface 14 as shown in FIG. 1(d), causes the blade edges 34 in the resulting grating plate 50 to point forward in a direction of cutting d in an optimal manner to maximize the ease of cutting. If the blades 26 were instead formed by etching only the first surface as disclosed in the prior art, then the blade edges 34 would instead point at the same angle as the lower surfaces 32 of teeth 24. Use of the grating tool would be more difficult because the blade edges would not point straight forward and the cutting would not be optimized. The etching process of the invention ensures that the blade edges 34 of the stamped grating tool point forward in the direction of cutting, instead of at an angle relative to the direction of cutting.

Variations of the foregoing process are considered to be within the scope of the invention. In one embodiment, the second surface 14 can be etched before the first surface 12 by first applying the patterned etching material 16 to the second surface and the masking material 22 to the first surface. In another embodiment, the second surface can be etched to a greater extent than the first surface (instead of the other way around) and the resulting teeth 24 and blades 26 can be stamped so that the blades project at an angle from the first surface.

FIGS. 2-5 illustrate different embodiments of grating plates that can be formed using the process of the invention. The grating plate 40 of FIG. 2 can be used to cut equally well in two opposing directions. The openings 42 are in the form of slits, with a center blade 44 between each pair of opposing slits 42. Each blade 44 has two blade edges 46 and 48. The blades 44 are stamped so that each blade edge 46 cuts when the grating plate 40 moves in a forward direction, and each blade edge 48 cuts when the grating plate 40 moves in a reverse direction.

FIG. 3 illustrates a grating plate 50 which can correspond to the grating plate 50 shown in section in FIG. 1(d). The etched openings 52 define teeth 24 which, in turn define blades 26 having sharp blade edges 34. The teeth 24 defining blades 26 are stamped to project at a slight angle relative to one of the first and second surfaces as shown in FIG. 1(d). The resulting grating tool is excellent for cutting in one direction.

FIG. 4 illustrates a grating plate 60 which is somewhat similar to the grating plate 50 of FIG. 3 except that the etched openings 62 defining teeth 64 and blades 66 are arranged in curved rows instead of in straight rows. FIG. 5 illustrates a grating plate 70 that is somewhat similar to the grating plate 50 of FIG. 3 except that the etched openings 72 define teeth 74 and blades 76 that are triangular instead of rectangular. Also, the teeth 74 and blades 76 are relatively smaller in size and greater in number, to provide for a finer grating operation.

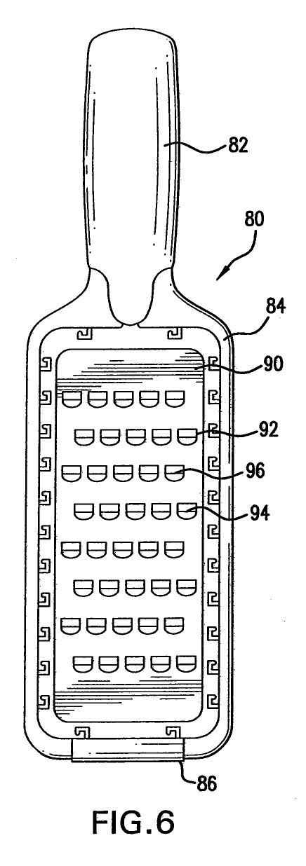

FIG. 6 illustrates a hand-held grating tool 80 including a handle 82, frame 84, mounting clamp 86 and grating plate 90. The relatively large etched openings 92 define blades 96 along stamped curved edges 94 of the openings. The grating tool 80 is useful for relatively coarse grating operations due to the configuration of grating plate 90. Notably, the grating plate 90 may be replaced with any of the grating plates 40, 50, 60 and 70 described above, rendering the grating tool 80 useful for a wide variety of grating applications. The etching process of the invention leads to improved blade design and ease of cutting for grating tools using any of these grating plate designs.

I claim:

1. A process for making a grating tool, comprising the steps of:
providing a metal blank having first and second opposing surfaces;
applying an etching resistant material on the first surface in a first pattern defining exposed areas and resistant areas;
masking the second surface;
etching the first surface in the exposed areas of the first pattern while the second surface is masked;
unmasking the second surface;
applying an etching resistant material on the second surface in a second pattern defining exposed areas corresponding to the exposed areas in the first pattern and resistant areas;
masking the first surface;
etching the second surface in the exposed areas of the second surface while the first surface is masked; and
unmasking the first surface;
wherein the etching of the first and second surfaces forms openings and blades in the corresponding exposed areas of the first and second patterns.

2. The process of claim 1, wherein the etching of the first surface penetrates about 55-75% of a thickness of the metal blank and the etching of the second surface penetrates about 25-45% of the thickness.

3. The process of claim 1, further comprising the step of stamping the metal blank so that the blades project at an angle above one of the first and second surfaces.

4. The method of claim 3, wherein the angle is about 5-30 degrees.

5. The method of claim 2, further comprising the step of stamping the metal blank so that the blades project at an angle from the second surface.

6. The method of claim 1, wherein the metal blank is selected from the group consisting of stainless steel, titanium, titanium-coated steel, steel coated with nano-particles of mineral oxide, and combinations thereof.

7. The method of claim 1, wherein the etching of the first and second surfaces is performed using an aqueous acid solution.

8. The method of claim 1, further comprising the steps of rinsing the first surface after the first surface is etched and rinsing the second surface after the second surface is etched.

9. A process for making a grating tool, comprising the steps of
providing a metal blank having first and second surfaces;
treating the first surface in a first pattern defining exposed areas and resistant areas;
etching the first surface in the exposed areas of the first pattern;
treating the second surface in a second pattern defining exposed areas corresponding to exposed areas of the first pattern and resistant areas;
etching the second surface in the exposed areas of the second pattern to form openings and blade edges in the exposed areas of the second pattern corresponding to exposed areas of the first pattern; and
stamping the metal blank so that the blades project at an angle above one of the first and second surfaces.

10. The process of claim 9, wherein the second pattern is a mirror image of the first pattern.

11. The process of claim 9, wherein the etching on one of the first and second surfaces proceeds to a greater extent than the etching on the other of the first and second surfaces.

12. The process of claim 11, wherein the etching on the one of the of the first and second surfaces penetrates at least about 55% of a thickness of the metal blank and the etching on the other of the first and second surfaces penetrates up to about 45% of the thickness.

13. The process of claim 9, further comprising the steps of covering the second surface during etching of the first surface and covering the first surface during etching of the second surface.

14. The process of claim 9, wherein the etching of the first and second surfaces is performed using an aqueous acid solution.

15. A process for making a grating tool, comprising the steps of:
providing a metal blank having first and second surfaces;
defining a first pattern on the first surface having a plurality of exposed areas;
etching the first surface in the exposed areas of the first pattern;
defining a second pattern on the second surface having a plurality of exposed areas corresponding to exposed areas of the first pattern;
etching the second surface in the exposed areas to form openings and blades in the exposed areas of the second pattern corresponding to the exposed areas of the first pattern; and
stamping the metal blank so that the blades project at an angle above one of the first and second surfaces.

16. The process of claim 15, wherein the second pattern is a mirror image of the first pattern.

17. The process of claim 15, wherein the openings comprises rectangles and the blades are formed along an edge of each rectangle.

18. The process of claim 15, wherein the openings define teeth and the blades are formed along at least one edge of each tooth.

19. The process of claim 15, wherein the openings comprise slits and the blades are formed along at least one edge of each slit.

20. The process of claim 15, wherein the etching of one of the first and second surfaces penetrates at least about 55% of the thickness of the metal blank and the etching of the other of the first and second surfaces penetrates up to about 45% of the thickness.
